(19) United States
(12) Patent Application Publication
(10) Pub. No.: US 2025/0125643 A1
(43) Pub. Date: Apr. 17, 2025

(54) CHARGER

(71) Applicant: TOYOTA JIDOSHA KABUSHIKI KAISHA, Toyota-shi (JP)

(72) Inventor: Masafumi HAYAKAWA, Toyokawa-shi (JP)

(73) Assignee: TOYOTA JIDOSHA KABUSHIKI KAISHA, Toyota-shi (JP)

(21) Appl. No.: 18/780,746

(22) Filed: Jul. 23, 2024

(30) Foreign Application Priority Data
Oct. 11, 2023 (JP) 2023-176211

(51) Int. Cl. H02J 7/00; H02M 1/44; H02M 7/5395

(52) U.S. Cl. CPC H02J 7/00711; H02M 7/5395; H02J 2207/20; H02M 1/44

(57) ABSTRACT

The charger includes a controller for controlling the booster circuit. The controller includes a FB module, a FF module, and a driver. The controller (1) identifies the disturbance peak frequency on the board diagram of the disturbance transfer function from the target voltage to the current flowing through the reactor by sweeping the target voltage while setting FB command to zero, and (2) determines FB gain included in FB module such that the difference between the control peak frequency on the board diagram of the control transfer function of the controller and the disturbance peak frequency is larger than the predetermined threshold frequency width when it is assumed that the ideal power supply is connected to the low voltage terminal.

### CROSS-REFERENCE TO RELATED APPLICATION

This application claims priority to Japanese Patent Application No. 2023-176211 filed on Oct. 11, 2023, incorporated herein by reference in its entirety.

### BACKGROUND

### 1. Technical Field

The technology disclosed herein relates to a charger including a booster circuit and a controller.

### 2. Description of Related Art

Japanese Unexamined Patent Application Publication No. 2021-175363 (JP 2021-175363 A), for example, discloses a charger that charges a battery of a battery electric vehicle. The battery electric vehicle includes an electric motor that drives wheels and an inverter that converts direct-current (DC) power of the battery into alternating-current (AC) power and supplies the AC power to the electric motor. The charger according to JP 2021-175363 A uses a coil of the electric motor and a switching element of the inverter as a booster circuit. The charger according to JP 2021-175363 A can charge a battery having a voltage higher than the voltage of a power supply by using the booster circuit.

### SUMMARY

A controller of the charger includes a feedback module to bring the difference between the target voltage of the booster circuit and the actual voltage to zero. When the electrical characteristics of the power supply connected to the low-voltage end of the booster circuit are close to the control characteristics of the feedback module, there is a possibility that the voltage fluctuation (or the current fluctuation) of the booster circuit during the feedback control becomes large due to interference between the characteristics. The present specification provides a charger capable of adjusting its own control system so as to reduce interference with the electrical characteristics of a power supply.

An aspect of the present specification provides a charger including a booster circuit and a controller. The booster circuit has a low-voltage end connected to a power supply and a high-voltage end connected to a battery. The booster circuit includes a reactor and a switching element for boosting a voltage at the low-voltage end and outputting the boosted voltage from the high voltage end. The controller drives the switching element such that an actual voltage at the low-voltage end matches a target voltage.

The controller includes a feedback module, a feedforward module, and a driver. The feedback module outputs a feedback command based on a difference between a square of the target voltage and a square of the actual voltage. The feedforward module outputs a feedforward command based on the target voltage. The driver generates a duty command for the switching element from the sum of the feedback command and the feedforward command, and generates a pulse width modulation signal having the duty ratio. The generated pulse width modulation signal is supplied to the switching element. In the following, the pulse width modulated signal will be referred to as a Pulse Width Moduration (PWM) signal.

Prior to starting charging, the controller executes the following two processes. (1) To specify a disturbance peak frequency on a Bode diagram of a disturbance transfer function from the target voltage to a current flowing through the reactor by frequency sweeping the target voltage while setting the feedback command to zero. (2) To determine a feedback gain included in the feedback module such that a difference between a control peak frequency on a Bode diagram of a control transfer function of the controller at a time when it is assumed that an ideal power supply that does not cause disturbance is connected to the low-voltage terminal and the disturbance peak frequency is greater than a predetermined threshold frequency width. Through the above processes, interference between the disturbance transfer function and the control transfer function can be avoided, and the influence of the electrical characteristics of the power supply on the feedback control of the controller caused when the battery is charged can be suppressed.

The charger disclosed herein can suppress the influence of the electrical characteristics of the power supply on the feedback control even when a power supply with unknown electrical characteristics is connected.

The controller preferably determines the feedback gain such that the control peak frequency is higher than the disturbance peak frequency. When the control band covers the disturbance band, it is possible to reduce the difference between the target voltage and the actual voltage including the disturbance.

The controller preferably stores a plurality of different feedback gains and the control peak frequency at a time when each of the feedback gains is selected. In this case, the controller selects, among the feedback gains, a feedback gain for which the difference between the control peak frequency and the disturbance peak frequency is greater than the threshold frequency width and which is closest to the threshold frequency width. The control transfer function of the controller at the time when it is assumed that an ideal power supply that does not cause disturbance is connected to the low-voltage end can be obtained in advance through simulation. The “ideal power supply that does not cause disturbance” may be set as a power supply model in which the output current of the power supply is constant regardless of the voltage fluctuation at the low-voltage end in the simulation. A plurality of different feedback gains and a control peak frequency at the time when each of the feedback gains is selected can be obtained in advance through simulation. The controller can determine a feedback gain quickly after specifying the disturbance peak frequency.

Details and further improvements of the technique disclosed herein will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a circuit diagram of a charger, a power supply, and a battery;

FIG. 2 is a schematic diagram of FIG. 1 rewritten as a control block diagram;

FIG. 3 is a Bode diagram of a control system and a power supply of a charger; and

FIG. 4 is a flowchart of a gain determination process performed by the controller.

### DETAILED DESCRIPTION OF EMBODIMENTS

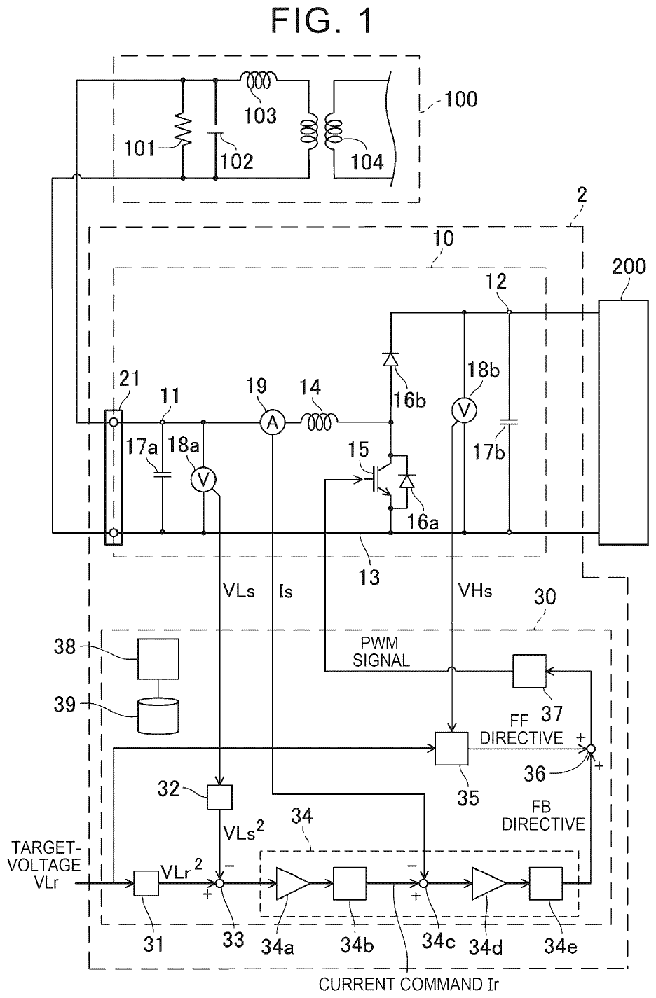

The charger 2 of the embodiment will be described with reference to the drawings. FIG. 1 shows a circuit diagram of a charger 2, a power supply 100, and a battery 200. The output voltage of the power supply 100 is lower than the voltage of the battery 200. The charger 2 is a device for boosting the output voltage of the power supply 100 and charging the battery 200 with the power of the power supply 100. The power supply 100 includes various passive elements such as a resistor 101 and a capacitor 102, but the specific structure (electrical characteristics) thereof may be unknown. In FIG. 1, the resistor 101, the capacitor 102, the coil 103, and the transformer 104 are illustrated in the power supply 100, but these passive elements are merely examples.

The charger 2 and the battery 200 are mounted on a battery electric vehicle. The power supply 100 is installed in a charging station or the like outside battery electric vehicle. The power supply 100 and the charger 2 are connected to each other via a charging port 21 provided on a side surface of battery electric vehicle.

The charger 2 includes a booster circuit 10 and a controller 30 that controls the booster circuit 10. The controller 30 controls the booster circuit 10 so as to appropriately charge the battery 200, but the control (in particular, feedback control) may be influenced by the electrical characteristics of the power supply 100. The charger 2 according to the embodiment suppresses the electrical characteristics of the power supply 100 interfering with the control characteristics of the charger 2, thereby deteriorating the control performance of the charger 2. Specifically, the controller 30 of the charger 2 determines the gain (FB gain) of the feedback control so that the peak frequency of the feedback control system does not overlap with the peak frequency of the electric identification (board diagram) of the power supply 100.

The main components of the controller 30 as hardware are a central processing unit (CPU 38) and a storage device 39, and a plurality of candidates for FB gain are stored in the storage device 39. The storage device 39 also stores a program defining a process to be executed by CPU 38.

The booster circuit 10 will be described. A power supply 100 is connected to the low voltage end 11 of the booster circuit 10, and a battery 200 is connected to the high voltage end 12. The booster circuit 10 includes a reactor 14 and a switching element 15 for boosting the voltage at the low voltage end 11 and outputting the boosted voltage from the high voltage end 12. More specifically, the booster circuit 10 includes a reactor 14, a switching element 15, a diode 16a, 16b, and a capacitor 17a, 17b. A reactor 14 and a diode 16b are connected in series between a low voltage end 11 and a high voltage end 12 of the booster circuit 10. One end of the reactor 14 is connected to the low voltage end 11, and the other end is connected to the anode of the diode 16b. The cathode of the diode 16b is connected to the high-voltage end 12. One end (high potential side) of the switching element 15 is connected between the reactor 14 and the diode 16b, and the other end (low potential side) of the switching element 15 is connected to the ground line 13. A diode 16a is connected in anti-parallel to the switching element 15. A capacitor 17a is connected between the low voltage end 11 and the ground line 13, and a capacitor 17b is connected between the high voltage end 12 and the ground line 13.

The booster circuit 10 includes a voltage sensor 18a that measures the voltage at the low voltage end 11, a voltage sensor 18b that measures the voltage at the high voltage end 12, and a current sensor 19 that measures the current flowing through the reactor 14. The measured values of the sensors are sent to the controller 30. The controller 30 controls the switching element 15 based on the measured values of the sensors. Since the structure of the booster circuit 10 shown in FIG. 1 is well known, detailed description of the operation will be omitted.

The measured value of the voltage sensor 18a is an actual voltage (actual voltage VLs) of the low voltage end 11, and the measured value of the voltage sensor 18b is an actual voltage (actual voltage VHs) of the high voltage end 12. The measured value of the current sensor 19 is a current (actual current Is) actually flowing through the reactor 14.

The controller 30 drives the switching element 15 with a predetermined duty 20 cycle Pulse Width Moduration (PWM) signal. The voltage ratio (step-up ratio) between the low voltage end 11 and the high voltage end 12 is determined by the duty ratio defined by PWM signal. The high voltage end 12 is connected to the battery 200, and the voltage at the high voltage end 12 corresponds to the voltage VB of the battery 200. The target voltage at the high voltage end 12 is represented by a symbol VHr, and the target voltage at the low voltage end 11 is represented by a VLr. As described above, the duty ratio included in PWM signal determines the boost ratio Vratio (=VHr/VLr). Here, the target voltage VHr of the high voltage end 12 corresponds to the battery voltage VB. Therefore, the control target value of the booster circuit 10 may be the voltage (target voltage VLr) of the low voltage end 11. Specifically, since it is the target boost ratio Vratio=VB/VLr, it becomes the target voltage VLr=VB/Vratio. The controllers 30 drive the switching elements 15 so that the actual voltage VLs at the low voltage end 11 matches the target voltage VLr.

The controllers 30 control the booster circuit 10 (the switching elements 15) based on the target-voltage VLr and the measured values of the sensors 18a, 18b and 19. Next, the configuration of the controller 30 will be described.

The controllers 30 include square calculators 31 and 32, a differentiator 33, a 34c, a multiplier 34a, 34d, a feedforward module 35 (a FF module 35 for short), a PID controller 34b, PI controller 34e, an adder 36, and drivers 37. All of these blocks may be implemented by software, or some of these blocks may be configured by hardware. The multiplier 34a, 34d, PID controller 34b and the differentiator 34c, PI controller 34e are collectively referred to as a feedback module 34 (a FB module 34 for short).

When the booster circuit 10 is connected to the battery 200, the actual voltage VHs at the high voltage end 12 becomes equal to the battery voltage VB. The target boost ratio Vratio=VB/VS=VHr/VLr required to boost the output voltage VS of the power supply 100 to the battery voltage VB is determined. As described above, since the target voltage VHr of the high voltage end 12 is equal to the battery voltage VB, the input to the control system may be the target voltage VLr of the low voltage end 11. The controllers 30 drive the switching elements 15 such that the actual voltage VLs at the low voltage end 11 matches the target voltage VLr. During charging, the current flowing through the reactor 14 and the actual voltage VLs at the low voltage end 11 fluctuate. Therefore, performing the control so that the actual voltage VLs matches the target voltage VLr leads to an electrically stable charge.

The target-voltage VLr is inputted to the square calculator 31. The square calculator 31 calculates the square of the target-voltage VLr. The measured value of the voltage sensor 18a (that is, the actual voltage VLs of the low voltage end 11) is inputted to the square calculator 32. The square calculator 32 calculates the square of the actual voltage VLs. In the differentiator 33, the difference between the square VLr² of the target voltage VLr and the square VLs² of the actual voltage VLs is calculated. Hereinafter, for convenience of explanation, the difference between the square VLr² of the target voltage VLr and the square VLs² of the actual voltage VLs may be referred to as a “square difference”.

The square of the voltage means electrical energy. Therefore, the squared difference corresponds to the difference between the target electrical energy and the energy actually supplied from the power supply 100. Reducing the squared difference is equivalent to reducing the difference between the actual voltage VLs at the low voltage end 11 and the target voltage VLr. It is desirable that the square difference be zero. In other words, the controllers 30 control the booster circuit 10 (the switching elements 15) so that the actual voltage VLs matches the target voltage VLr.

The squared difference is inputted to FB module 34. FB module 34 first multiplies the squared difference by the voltage FB gain at the multiplier 34a. The voltage FB gain is given by the inverse of the capacitance Cf of the capacitor 17a (1/Cf). A value obtained by multiplying the square difference by the voltage FB gain is inputted to PID controller 34b. In PID controller 34b, the squared difference multiplied by the voltage FB gain is inputted to a proportional control term, an integral control term, and a differential control term. The proportional control term, the integral control term, and the differential control term are not shown. The sum of the outputs of the proportional control term, the integral control term, and the differential control term is the output of PID controller 34b. Since PID controller 34b is well known, detailed explanation is omitted. The output of PID controller 34b is a target value (current command Ir) of the current flowing through the reactor 14.

The actual current (actual current Is) flowing through the reactor 14 is measured by the current sensor 19. The difference (current difference) between the current command Ir and the actual current Is is calculated by the differentiator 34c. The current difference is inputted to the multiplier 34d. The multiplier 34d multiplies the current difference by a predetermined current FB gain. The current FB gain is given by “−L/Tc/VHr”. Here, the symbol L is an inductance of the reactor 14, the symbol Tc is a control period, and the symbol VHr is a target voltage of the high voltage end 12. As mentioned above, the target voltage VHr at the high voltage end 12 is equal to the battery voltage VB.

The current difference multiplied by the current FB gain is inputted to PI controller 34e. In PI controller 34e, the current difference multiplied by the current FB gain is inputted to the proportional control term and the integral control term. The illustration of the proportional control term and the integral control term is omitted. The sum of the outputs of the proportional control term and the integral control term is the output of PI controller 34e. Since PI controller 34e is also well known, detailed explanation is omitted. The output of PI controller 34e (i.e., the output of FB module 34) provides a feedback command to bring the squared difference close to zero. In other words, the output of FB module 34 is a feedback command (FB command) for matching the actual voltage VLs of the low voltage end 11 with the target voltage VLr.

On the other hand, the target-voltage VLr is also inputted to FF module 35. FF module 35 multiplies the inverse of the target voltage VLr by the actual voltage Vs of the high voltage end 12. That is, FF module 35 outputs the actual voltage Vs/target voltage VLr. The output of FF module 35 is a feedforward command (FF command) for bringing the boost ratio (high voltage end voltage/low voltage end voltage) of the booster circuit 10 close to the target boost ratio Vratio. In other words, the output of FF module 35 is a FF command for bringing the actual voltage VLs of the low voltage end 11 close to the target voltage VLr.

FF command and FB command are summed by the adder 36. The adder 36 outputs a step-up ratio command for causing the step-up ratio (high voltage end voltage/low voltage end voltage) of the booster circuit 10 to follow the target step-up ratio Vratio. The boost ratio command is input to the driver 37. The driver 37 converts the boost ratio command into a duty ratio (Duty command). Drivers 37 also generate PWM signal from Duty commands. PWM signal generated by the driver 37 is a pulse signal having a period Tc, and the ratio of HIGH potential in the control period Tc of one pulse corresponds to the duty cycle. PWM signal outputted from the driver 37 is supplied to the switching element 15.

As shown in FIG. 1, a feedback loop based on a difference (squared difference) between the target voltage VLr and the actual voltage VLs is formed in the controllers 30. When the controller 30 drives the switching element 15, the actual voltage VLs at the low voltage end 11 follows the target voltage VLr. More specifically, the actual voltage VLs rapidly approaches the target voltage VLr by FF command. The variation in the difference between the actual voltage VLs and the target voltage VLr is suppressed by FB command.

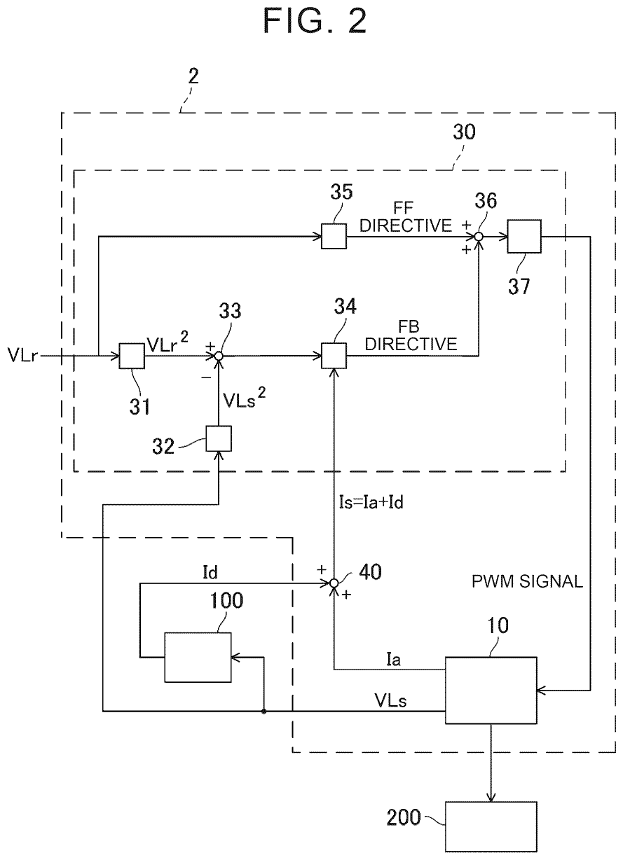

As mentioned above, the power supply 100 includes several passive elements, but the electrical characteristics of the power supply 100 are unknown. Electrical characteristics of the power supply 100 may affect feedback control of the controller 30. This will be explained using FIG. 2.

FIG. 2 is a diagram in which the circuit diagram of FIG. 1 is rewritten as a control block. In FIG. 2, the elements (multiplier 34a, 34d, PID controller 34b and differential 34c, PI controller 34e) in FB module 34 are not shown.

The controller 30 generates a control value (PWM signal) based on the target voltage VLr of the low voltage end 11, the actual voltage VLs, and the current flowing through the reactor 14 (actual current Is), and supplies the generated PWM signal to the booster circuit 10 (switching element 15).

The controllers 30 include a FB module 34, a FF module 35, and drivers 37. FB module 34 outputs a FB command based on the squared difference between the target voltage VLr and the actual voltage VLs. Note that an actual current Is is also used to generate FB command (see FIG. 1). FF module 35 outputs a FF command based on the target voltage VLr. The driver 37 generates a Duty command for the switching device from the sum of FB command and FF command, and generates a PWM signal including Duty command. The generated PWM signal is supplied to the booster circuit 10 (switching element 15).

While the switching element 15 is being driven, the actual voltage VLs fluctuates due to various factors. The fluctuation of the actual voltage VLs appears as the fluctuation of the current flowing through the reactor 14 through the electric property of the power supply 100. Hereinafter, the current flowing through the reactor 14 is simply referred to as a reactor current. The fluctuation of the reactor current caused by the electrical characteristics of the power supply 100 becomes a disturbance to the control system. Therefore, the variation of the reactor current caused by the electric property of the power supply 100 is referred to as a disturbance current Id. In addition, the transfer function until the variation of the actual voltage VLs appears as the variation of the actual current Is through the electric property of the power supply 100 is referred to as a disturbance transfer function.

Most of the reactor current flows due to the operation of the switching element 15. The reactor current caused by the operation of the switching element 15 is referred to as a main current Ia. The actual current Is measured by the current sensor 19 is the sum of the main current la and the disturbance current Id. The adder 40 of FIG. 2 indicates that the sum of the main current Ia and the disturbance current Id is sent to the controllers 30 as an actual current Is.

As is apparent from FIGS. 1 and 2, the current flowing through the reactor 14 due to the electric property of the power supply 100 can be regarded as disturbance (disturbance current Id) for the control system. The disturbance current Id affects FB command. If the peak frequency of the transfer function of FB module 34 is close to the peak frequency of the disturbance current Id, the effect thereof increases. Specifically, FB command is greatly disturbed by the variation of the disturbance current Id.

Therefore, after the power supply 100 is connected, the controller 30 performs the following process prior to charging the battery 200, and adjusts the parameters (FB gain) of the control system so as to reduce the effect of the disturbance current Id (that is, the electric property of the power supply 100).

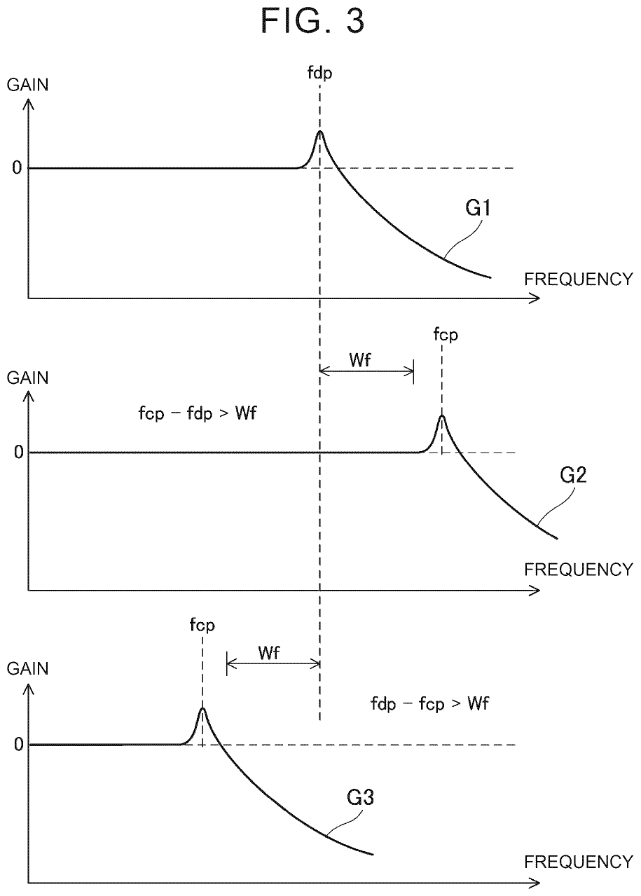

(Process 1) First, the controller 30 frequency-sweeps the target voltage VLr while setting FB command to zero, and acquires a board-diagram of the disturbance transfer function from the target voltage VLr to the reactor current (actual current Is). Then, the controller 30 specifies the peak frequency (disturbance peak frequency) on the board diagram. By “frequency sweeping the target voltage VLr” is meant oscillating the target voltage VLr while gradually increasing from zero frequency. The controller 30 measures the actual current Is at predetermined frequency intervals while gradually increasing the oscillation frequency of the target voltage VLr. The “actual current Is/target voltage VLr” at each frequency corresponds to the gain on the Bode-diagram. In the upper part of FIG. 3, a graphical G1 of an exemplary disturbance transfer function is shown. The symbol fdp represents the disturbance peak-frequency. Although the transfer function from the variation of the actual voltage VLs to the disturbance current Id is a disturbance transfer function, the variation of the actual voltage VLs is equal to the variation of the target voltage VLr because FB command is set to zero. Therefore, FB command is set to zero and the target-voltage VLr is frequency-swept to obtain a board diagram of the disturbance transfer function.

When the peak frequency on the board-line diagram of the control system is close to the disturbance peak frequency fdp, the control performance deteriorates. The controller 30 executes the following (Process 2).

(Process 2) The controller determines FB gain included in FB module 34 such that the difference between the control peak frequency fcp and the disturbance peak frequency fdp on the board diagram of the control transfer function when it is assumed that an ideal power supply that does not cause disturbance is connected to the low voltage end 11 is larger than a predetermined threshold frequency width Wf. The graph G2 in the middle of FIG. 3 is a Bode diagram when the control peak frequency fcp is greater than the disturbance peak frequency fdp by more than the threshold frequency width Wf (fcp−fdp>Wf). The lower graphical G3 of FIG. 3 is a Bode diagram when the disturbance peak frequency fdp is greater than the control peak frequency fcp by more than the threshold frequency width Wf (fdp−fcp>Wf). Both graphs G2 and G3 represent the |fdp−fcp|>Wf case. The controllers 30 determine FB gains of FB modules 34 such that the board-diagram of the control system is in a graph G2 or G3. The threshold-frequency-width Wf is set to, for example, tens of kilohertz.

The storage device 39 of the controller 30 stores a plurality of FB gains and control peak-frequency fcp when the respective FB gains are selected. Note that the “control transfer function of the controller when it is assumed that an ideal power supply that does not cause disturbance is connected to the low-voltage terminal” is obtained in advance by simulation. In the “ideal power supply that does not cause disturbance”, in the simulation, a power supply model in which the output current of the power supply becomes constant even if the voltage at the low voltage end fluctuates may be set. The plurality of FB gains that differ from each other and the control peak frequencies when the respective FB gains are selected are stored in advance in the storage device 39 of the controller 30.

The controller 30 selects FB gain such that the difference between the control peak frequency fcp and the disturbance peak frequency fdp is greater than the threshold frequency width Wf and closest to the threshold frequency width Wf from among the plurality of FB gains. Controller 30 selects a FB gain corresponding to a control peak frequency fcp that is larger than the disturbance peak frequency fdp when there is a control peak frequency fcp that is a candidate for each of the low frequency side and the high frequency side of the disturbance peak frequency fdp.

By increasing the difference between the control peak frequency fcp and the disturbance peak frequency, the effect of the electric property of the power supply 100 on the feedback control can be suppressed.

FB gain includes a voltage FB gain set in the multiplier 34a of FIG. 1 and a current FB gain set in the multiplier 34d. FB gains may include gains (proportional gain, integral gain, differential gain) included in PID controller 34b and PI controller 34e, in addition to their gains.

Since the voltage FB gain includes the capacitance of the capacitor 17a, it cannot be adjusted by the software of the controller 30 (the control program of the controller 30). On the other hand, the current FB gain includes a control period Tc. The control period Tc of the controllers 30 is equal to the period of the carrier waves used to generate PWM signals. More precisely, the control period Tc is equal to an integral multiple of the period of the carrier wave. Therefore, FB gain can be adjusted by adjusting the period of the carrier wave. This adjustment is possible by software. In addition, the proportional gain, the integral gain, and the differential gain included in PID controller 34b and PI controller 34e can also be changed by software. As described above, FB gain corresponding to each of the plurality of different-control-peak-frequency fcp is determined in advance by simulation and stored in the storage device 39.

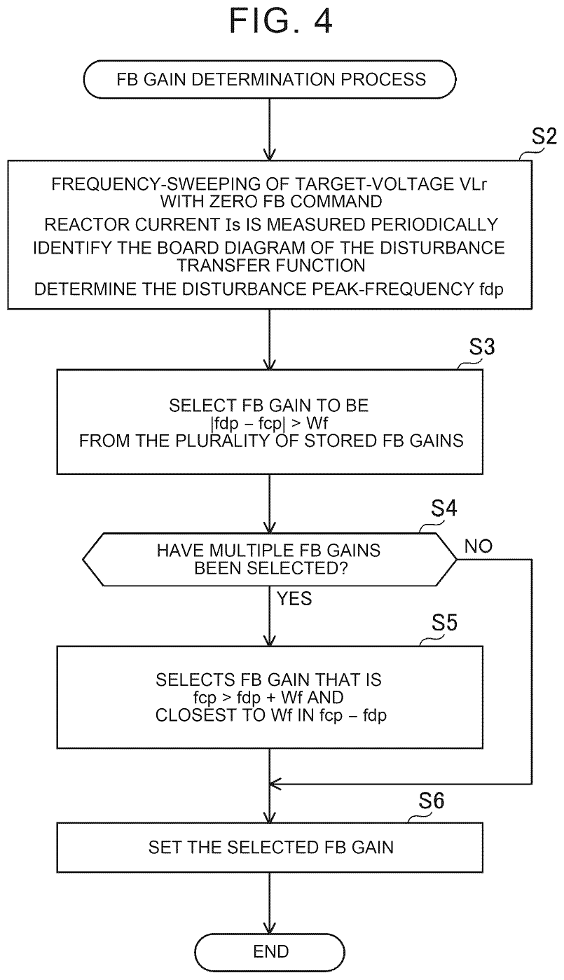

FIG. 4 shows a flow chart of FB gain determination process. In S2, the following process is performed. The controller 30 frequency-sweeps the target voltage VLr while setting FB command to zero. The actual voltage VLs also varies in frequency according to the frequency sweep of the target voltage VLr. During frequency sweeping, the reactor current (actual current Is) is measured at predetermined frequency intervals. The actual current Is/target-voltage VLr is plotted on a frequency-graph. That is, a board diagram of the disturbance transfer function is obtained. The controller 30 specifies a peak (disturbance peak frequency) in the disturbance board diagram.

When the frequency sweeping is finished, the controllers 30 execute S3. In S3, the controllers 30 select FB gains that are |fdp−fcp|>Wf from the plurality of FB gains stored in the storage device 39.

When a plurality of FB gains are selected in S3 (S4: YES), S5 is executed. Controller 30 selects one FB gain that is fcp−fdp>Wf and closest to Wf between fcp and fdp. Controller 30 sets the selected FB gain to FB gain of FB module 34 (S6). When one FB gain is selected in S4, the controller 30 sets the selected FB gain to the gain of FB module 34 (S4: NO, S6).

Through the above process, FB gain that can suppress the effect of the electric properties of the power supply 100 is set in the control system. When the process of FIG. 4 is completed, the controller 30 drives the switching element 15 using the set FB gain to charge the battery 200.

The controllers 30 measure the actual transfer function (disturbance transfer function) of the power supply 100 and then set FB gain. Therefore, the charger 2 can realize the feedback control in which the influence of the electric characteristics of the power supply (the influence of the disturbance) is small even when the power supply having the unknown electric characteristics is connected.

Points to be noted regarding the technique described in the embodiment will be described. The charger may include a plurality of booster circuits connected in parallel. Techniques are known in which a switching element of an inverter and a coil of an electric motor are used as a step-up converter. The coil of the electric motor functions as a reactor.

In this case, each of the three-phase coils and the switching element constitutes a booster circuit. The inverter and the electric motor constitute three booster circuits connected in parallel. The charger disclosed in the present specification may include a plurality of booster circuits using a switching element of an inverter and a coil of an electric motor.

PID controller 34b and PI controller 34e are well known. Control system designing techniques for PID controller 34b and PI controller 34e are also well known. The charger 2 disclosed in this specification is characterized in that a plurality of FB gains are prepared in advance in the controllers 30, and an appropriate FB gain (a FB gain suitable for suppressing disturbance) is set in accordance with the electric properties of the connected power sources.

A PI controller or a PD controller may be used instead of PID controller 34b that defines the control rules of FB module 34. Similarly, a PID controller or a PD controller may be employed instead of PI controller 34e.

Although the specific examples have been described in detail above, these are merely examples and do not limit the scope of claims. The techniques described in the claims include various modifications and alternations of the specific examples illustrated above. The technical elements described in the present specification or the drawings exhibit technical usefulness alone or in various combinations, and are not limited to the combinations described in the claims at the time of filing. In addition, the techniques illustrated in the present specification or drawings can achieve a plurality of objectives at the same time, and achieving one of the objectives itself has technical usefulness.

What is claimed is:

1. A charger comprising:
a booster circuit having a low-voltage end connected to a power supply and a high-voltage end connected to a battery, and including a reactor and a switching element for boosting a voltage at the low-voltage end and outputting the boosted voltage from the high-voltage end; and
a controller that drives the switching element such that an actual voltage at the low-voltage end matches a target voltage, wherein:
the controller includes
a feedback module that outputs a feedback command based on a difference between a square of the target voltage and a square of the actual voltage,
a feedforward module that outputs a feedforward command based on the target voltage, and
a driver that generates a pulse width modulation signal for driving the switching element from a sum of the feedback command and the feedforward command; and
the controller is configured to
specify a disturbance peak frequency on a Bode diagram of a disturbance transfer function from the target voltage to a current flowing through the reactor by frequency sweeping the target voltage while setting the feedback command to zero, and
determine a feedback gain included in the feedback module such that a difference between a control peak frequency on a Bode diagram of a control transfer function of the controller at a time when it is assumed that an ideal power supply that does not cause disturbance is connected to a low-voltage terminal and the disturbance peak frequency is greater than a predetermined threshold frequency width.

2. The charger according to claim 1, wherein the controller determines the feedback gain such that the control peak frequency is higher than the disturbance peak frequency.

3. The charger according to claim 1, wherein the controller is configured to:
store a plurality of different feedback gains and the control peak frequency at a time when each of the feedback gains is set; and
select, among the feedback gains, a feedback gain for which the difference between the control peak frequency and the disturbance peak frequency is greater than the threshold frequency width and which is closest to the threshold frequency width.
